(19) United States
(12) Patent Application Publication
(10) Pub. No.: US 2025/0170986 A1
(43) Pub. Date: May 29, 2025

(54) SYSTEMS, DEVICES, AND METHODS FOR DETECTION AND PREVENTION OF VEHICLE THEFT OR BURGLARY

(71) Applicant: Brian Booker, Memphis, TN (US)

(72) Inventor: Brian Booker, Memphis, TN (US)

(21) Appl. No.: 18/435,992

(22) Filed: Feb. 7, 2024

Related U.S. Application Data
(60) Provisional application No. 63/443,858, filed on Feb. 7, 2023.

(51) Int. Cl. B60R 25/102; B60R 25/30

(52) U.S. Cl. CPC B60R 25/102; B60R 25/30

(57) ABSTRACT

Disclosed are systems, devices, and methods to detect and prevent theft or burglary of a vehicle. The method includes receiving, by a processor, at least one sensor input having a sensor value from at least one sensor of a plurality of sensors mounted on the vehicle. The method further includes determining, by the processor, whether the sensor value received from the at least one sensor is greater than a predetermined threshold value corresponding to the at least one sensor. The method further includes, in response to the determination by the processor, causing an alarm notification indicating a theft of the vehicle to be generated at a user device. Additionally, the system allows for monitoring a person's presence within a target vehicle with acknowledgement permitted thereof within the application to indicate if such a person is authorized for use of such a target vehicle.

### CROSS-REFERENCE TO RELATED APPLICATION

This application claims the benefit of pending U.S. Provisional Patent Application No. 63/443,858, filed on Feb. 7, 2023, the entirety of which is herein incorporated by reference.

### FIELD OF THE DISCLOSURE

The present disclosure relates generally to systems and methods for anti-theft devices, and more particularly to the detection and/or prevention of vehicle theft or burglary. The system includes the utilization of a plurality of add-on sensors permitting detection of specific situations in relation to a target vehicle. A plurality of motion sensors coupled with at least one of a vibration sensor and a sound sensor provides a base platform wherein a computerized application may assess such different issues within a target vehicle. Additionally, the system allows for monitoring a person's presence within a target vehicle with acknowledgement permitted thereof within the application to indicate if such a person is authorized for use of such a target vehicle. Such a versatile system covers a number of different theft issues simultaneously, providing a reliable add-on product for vehicle protections.

### BACKGROUND OF THE DISCLOSURE

Vehicle tampering and theft has increased in present times. Whether due to constant increases of vehicle costs and values or simply due to certain elements of society desirous of stealing cars, the propensity of criminal activities of such a sort has grown, particularly over the last few years and in certain urban areas. Thieves also appear to constantly break into vehicles searching for valuables, firearms, and other items, on a regular basis. Thus, the desirability of vehicles to the thieves has also increased. It is forecasted that this trend will continue to grow in the future as well.

Thieves use various techniques to steal or burgle vehicles. For example, in certain scenarios, a thief breaks the window glass, the windshield, or the rear windshield and enters the vehicle. There is also the potential for thieves to use scanners and like devices to intercept radio frequency identification (RFID) signals from vehicle remote controls (fobs, and the like), thereby making it easier to use such stolen signals to unlock such vehicles and potentially start the same (due, ostensibly, to the common utilization nowadays of electronic ignition switches rather than mechanical solenoids requiring key-based devices). Certainly, as in the past, there are still instances where a thief deploys other tampering methods to start the vehicle (hotwiring, and the like). Worse yet, possibly, is the potential for what is termed “carjacking” where a thief enters an already-running vehicle at a stoplight, as one example, or, alternatively, a vehicle present at a store, gas station, etc., ousting the driver/user (and potentially any passengers), sometimes stealing valuables, including phones, purses, wallets, and the like, as well, leaving the user/driver (and any passengers) stranded as the vehicle is driven away. Additionally, in some other scenarios, a thief steals a vehicle by towing the vehicle using chains, ropes, bars, etc. In some cases, a thief or a burglar may approach the vehicle to steal contents from the vehicle (e.g., valuables inside the vehicle, or parts of the vehicle).

By the time the owner of a stolen vehicle realizes that the vehicle has been tampered with (e.g., stolen or burgled) the thief escapes and is almost impossible to track. The thief may then dismantle the vehicle and sell the parts of the vehicle, may simply take a “joyride” and abandon the vehicle (sometimes in a wrecked state), or undertake another criminal activity. In some scenarios, the thief may change the exterior of the vehicle making it difficult for the owner or the police to find the stolen vehicle.

There is thus a need for a solution to at least one of the aforementioned problems, particularly as an add-on system to already-manufactured vehicles, if possible (though not required). For instance, there is an established need for systems, devices, and methods that detect the vehicle theft or vehicle burglary, and immediately notifies the owner of the same. There is an established need for systems, devices, and methods that notifies the police of thefts or burglaries of vehicles in an area. Furthermore, there exists a need to provide a versatile system utilizing the same sensors and configurations thereof to provide the capability of monitoring and allowing for selected authorization of the presence of an individual within the target vehicle to permit surveillance thereof on demand. To date, such a versatile system has yet to be provided within the vehicle security industry.

### SUMMARY OF THE DISCLOSURE

The present disclosure is directed to a method to detect and prevent theft or burglary of vehicles. The method includes receiving, by a processor, at least one sensor input having a sensor value from at least one sensor of a plurality of sensors mounted on or inside a vehicle. The method further includes determining, by the processor, whether the sensor value received from the at least one sensor is greater than a predetermined threshold value corresponding to the at least one sensor. The method further includes, in response to the determination by the processor that the sensor value is greater than the predetermined threshold value, causing an alarm notification indicating a theft or burglary of the vehicle to be generated at a user device.

In an aspect, the plurality of sensors may comprise one or more of a motion sensor, an audio sensor, and a vibration sensor.

In an aspect, the notification may indicate a location of the vehicle and a time stamp when the vehicle was being stolen.

In an aspect, the method further comprises receiving a confirmation of the theft or burglary from the user device and transmitting the generated alarm notification indicating the theft or burglary of the vehicle to another user device.

In an aspect, the predetermined threshold value is stored in a memory or an external database.

In an aspect, the present disclosure is also directed to a system for detection and prevention of vehicle theft or burglary. The system comprises a user device associated with the vehicle, a theft detection device, a memory to store instructions, and a processor in communication with the memory. The theft detection device comprises a plurality of sensors. The processor may execute the instructions to perform or control performance of a method comprising: receiving, by the processor, at least one sensor input having a sensor value from at least one sensor of the plurality of sensors mounted on the vehicle. The method further comprises determining, by the processor, whether the sensor value received from the at least one sensor is greater than a predetermined threshold value corresponding to the at least one sensor. The method further comprises, in response to the determination by the processor that the sensor value is greater than the predetermined threshold value, causing an alarm notification indicating a theft or burglary of the vehicle to be generated at the user device.

Another potential embodiment is the utilization of at least three motion sensors within the interior of a target vehicle to provide instant notification to an app that a person is present within such a vehicle. In such a manner, the app and thus system allows for monitoring of the status of the interior of a target vehicle to subsequently notify the owner/driver of the vehicle of such a status and the ability then to click on the app to indicate authorization of such presence is permitted. If the system indicates an unauthorized individual present within the target vehicle, the app user/driver/owner of the target vehicle may then notify the local authorities through the app. Thus, whether the vehicle is unattended (parked, for instance) or being driven and subject to a carjacking episode, the system may notify the app and require user action to denote authorization of such presence. If carjacked, for example, if the app is not activated by the user, either direct notification to local authorities or notification to another app user within the same subscription may occur to then allow such local authorities notification subsequent thereto by such an another app user.

As another possible embodiment, were the vehicle fob/remote to be stolen or at least the RFID signal of the vehicle (with a hybrid or electrical vehicle, as examples), at least the IR motion detector indicates the presence of a person or persons within the subject vehicle. Such a situation then allows for notification to be sent to the app and the user or users to either grant authorization for such a presence or the ability to communicate with the local authorities that the vehicle has at least been broken into and the chance that it may be subject to an attempted theft. Such a possibility thus allows for notification if anyone is in the vehicle to steal contents therein as well. A time stamp records the moment it happens within the app as an aid for local authorities.

Certainly, the system may be combined in an embodiment with cameras, whether inside, outside, or both, in relation to the subject vehicle. Such an alternative would facilitate identification of any bad actors. The system may thus be outfitted with such camera devices in addition to the sensors and the app communication capabilities, with a recording capability within the app as well.

Another embodiment permits the inclusion of at least one tracking device (preferably more than one to militate against removal of such tracking devices by a bad actor during a theft or break-in) either provided separately or together with such sensors. In this manner, if the vehicle is actually stolen, such tracking devices embedded within the car allow for following as needed by the authorities.

As it is, the scope of the disclosure encompasses the utilization of the aforementioned sensors to allow for determination of an actual theft, break-in, carjacking, or other type of situation (a parked-car accident, for example) without the need for cameras or other such devices. For instance, if another vehicle or tree or other thing contacts the subject car, and thus causes a “crash” or other type of contact, but the IR RFID does not indicate a person is located within the car, the sensors may indicate that such an accident has occurred, providing notice thereof. As noted above, the presence of a camera or cameras may provide a benefit of the identification of such another vehicle, particularly if the situation is a hit-and-run event. Alternatively, if a person is present (through the motion sensor), and breakage has occurred (and noted by the sound and vibration sensors), the system may then deduce a bad actor is present, allowing for direct notification to authorities.

As noted above, any notification from the app to the local authorities may be supplied with specific subject vehicle information to potentially accelerate the time and chance of finding such a stolen vehicle as well as facilitate identification thereof after being found. Such information may include the vehicle ID (VIN) as well as the specific license plate number, make, model, and color.

A particularly important benefit of an embodiment of this disclosure is the capability of allowing a driver/passenger passive communication to authorities of a carjacking situation. In such an aspect, the system may at least provide a potential notification to multiple app users in case the driver loses his or her phone during such a theft. In such a situation, the initial entry into the vehicle by the driver and others will permit notification to the app that the individuals present in the vehicle are properly there. If any others enter the vehicle after indication to the app, then the user must notify the app of the further entry of other individuals. If no such notification is provided, and thus authorization in relation to the app (on the user/passenger's smartphone, for instance), the lack of such notification may indicate the presence of an unauthorized individual or individuals within the subject vehicle. If the user's phone is taken during such an event, such a lack of notification/authorization generates an automated notification to other app subscribers in relation to the same subject vehicle of the situation. If the user/passenger's app (smartphone) does not provide any further indication or communication, the system may thus deduce a problem has occurred and notification to local authorities may then commence. Combined with tracking devices related to such a subject vehicle and user/driver app may then facilitate location of such a vehicle and hoped-for apprehension of the carjacking suspect(s).

Such a system is thus, in one aspect, a vehicle add-on method through which such sensors, tracking devices, cameras, and app or provided as a single (or possibly base device with other such devices available separately) purchase by a user for installation (self- or professional installation capabilities) within/on a subject vehicle. Alternatively, such a system may be provided to a vehicle manufacturer for installation during manufacture thereof. Such a combined system may thus be a vehicle add-on with the ability to determine certain situations when individuals are not present as well as allow for proper consideration of the authority of a user/driver/passenger whenever the subject vehicle is entered, allowing for notification within the app of the presence of all persons therein at any time. Combined with the potential to have multiple sensors provide a suitable review of all situations involving the subject vehicle (based on motion, sound, and vibration), such a system allows for a reliable means to provide protection and prevention of theft or break-in by bad actors, both while the vehicle is idle (parked) and in use.

In an aspect, the present disclosure is also directed to a non-transitory computer readable storage medium comprising instructions executable by a processor, the instructions to cause the processor to carry out the methods described herein.

These and other objects, features, and advantages of the present disclosure will become more readily apparent from the attached drawings and the detailed description of the preferred embodiments, which follow.

### BRIEF DESCRIPTION OF THE DRAWINGS

The preferred embodiments of the disclosure will hereinafter be described in conjunction with the appended drawings provided to illustrate and not to limit the disclosure, where like designations denote like elements, and in which:

FIG. 1 shows a block diagram of an example system in accordance with embodiments of the present disclosure;

FIG. 2 shows a flowchart of an example method, in accordance with embodiments of the present disclosure;

FIGS. 3A and 3B show screen captures of example user interfaces of a user device, in accordance with embodiments of the present disclosure;

FIG. 4 shows an example representation of placement of sensors inside a vehicle, in accordance with embodiments of the present disclosure;

FIG. 5 shows an example of a risk categorization table, in accordance with embodiments of the present disclosure; and

FIGS. 6A and 6B show perspective views of a vehicle with a theft detection device mounted thereon, in accordance with embodiments of the present disclosure.

FIG. 7 shows a flowchart of an alternative example method, in accordance with embodiments of the present disclosure wherein a person's is detected within the subject vehicle;

FIG. 8 shows a screen capture of an example user interface of a user app device in relation to the detection denoted in FIG. 7.

Like reference numerals refer to like parts throughout the several views of the drawings.

### DETAILED DESCRIPTION OF THE DRAWINGS AND PREFERRED EMBODIMENTS

The following detailed description is merely exemplary in nature and is not intended to limit the described embodiments or the application and uses of the described embodiments. As necessarily to be construed as preferred or advantageous over other embodiments. All of the embodiments described below are exemplary embodiments provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed implementations. However, one skilled in the relevant art will recognize that implementations may be practiced without one or more of these specific details, or with other methods, components, materials, and the like.

The headings and Abstract of the Disclosure provided herein are for convenience only and do not interpret the scope or meaning of the implementations.

Shown throughout the figures, the present disclosure is directed toward a system, device, and method for detection and prevention of theft or burglary of a vehicle.

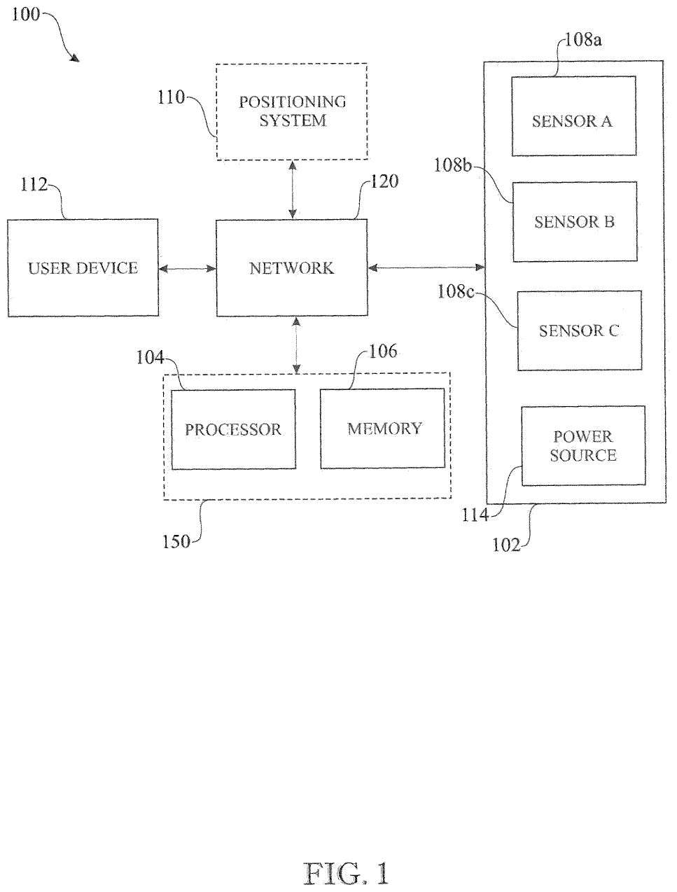

Referring initially to FIG. 1, a block diagram of a vehicle theft detection and prevention system 100 is illustrated. The system 100 may comprise a theft detection device 102 for use with a vehicle (not shown) and at least one user device 112. The system 100 may further comprise a processor 104, a memory 106, and optionally, a positioning system 110. The user device 112 may be a device associated with a user. In an embodiment, the user may be the owner of the vehicle. In another embodiment, the user device 112 may be a device associated with a public safety officer, for example a police official located nearest to the location of the vehicle.

The system 100 facilitates communication and exchange of information between the theft detection device 102 and the user device 112. To this end, the system 100 may comprise a communication network 120 that allows communication between the theft detection device 102 and the user device 112. The communication network 120 further allows communication among various components of the system 100, such as, the processor 104, the memory 106, the user device 112, the positioning system 110, and the theft detection device 102. The communication network may be any type of communication network including one or more of the Internet, local area networks (LAN), wireless networks, Radio Frequency (RF), Bluetooth, Near Field Communication (NFC), or the like.

In some embodiments, the processor 104 may be integrated within the user device 112. In some embodiments, the processor 104 may be an in-built processor of the user device 112. In some embodiments, the processor 104 may be located remote from the user device 112. In some embodiments, the memory 106 may be provided within the user device 112. In some embodiments, the memory 106 may be an in-built memory of the user device 112. In some embodiments, the memory 106 may be located remote from the user device 112.

In some embodiments, the processor 104 and the memory 106 may be separate components. In some embodiments, the processor 104 and the memory 106 may form a processing unit 150. The processing unit 150 may comprise a computer, e.g., a server computer, or a dedicated host device that facilitates communication with the user device 112 and the theft detection device 102. In some embodiments, the processing unit may be implemented as a cloud-based server. In some embodiments, the processing unit may be implemented using cloud computing, distributed computing, virtualized computing, or the like. In some embodiments, one or more functions of the processing unit may be performed by one or more components of the cloud server. For example, the processing unit may comprise a processor and a memory, as described above and below, either or both of which may be implemented as one or more components of a cloud server. It is appreciated that although the processing unit 150 is depicted as one unit, the processor 104 and the memory 106 may be implemented remote to each other and still functioning as a processing unit 150, for instance, the processor 104 may be integrated within the user device 112 while the memory 106 may be a cloud-based memory.

Though FIG. 1 shows the processing unit 150 being separate from the theft detection device 102, it is contemplated that the processing unit 150 may be implemented as a component of the theft detection device 102. In some embodiments, one or more of the processor 104 and the memory 106 may be implemented within the theft detection device 102.

The processing unit 150 may be configured to manage and control communication between the theft detection device 102 and the user device 112. In some embodiments, the user device 112 may comprise an application, for instance a software application, which is executable to communicate with the theft detection device 102. In some embodiments, the application may be a web application. In some embodiments, the application may be a mobile application. The mobile application may be installed on the user device 112. The user device 112 may be any type of electronic device, e.g., desktop computer, laptop computer, portable or mobile device, cell phone, smartphone, tablet computer, wearable device, or the like. In some embodiments, the application may be controlled or implemented by the processing unit 150.

In some embodiments, the user device 112 may comprise a user interface that allows the associated user to interact with the theft detection device 102, for instance via the application installed therein. For example, the application installed on the user device 112 (which may be controlled by the processing unit 150 in conjunction with the theft detection device 102) may present a user interface on the user device 112, which enables the methods to be performed being described herein. In other words, the processing unit 150 in conjunction with the theft detection device 102 may execute or control such software application to perform or control performance of theft detection methods described herein, including example method 200 for detection and prevention of vehicle theft.

The user interface may comprise a graphical user interface (GUI), a touch based user interface, a voice user interface or the like. For example, if the user device 112 is a mobile device, a display screen of the mobile device may present the user interface for the user to provide or input data. As described above, the user interface of the user device 112 may be provided under control of the software application program (e.g., mobile application) installed on the user device 112.

The user interface of the user device 112 (e.g., GUI based user interface, voice based user interface, or touch based user interface), which is presented under control of the processing unit 150 in conjunction with the theft detection device 102, may enable information about a vehicle, where the theft detection device 102 is located, to be provided to a user associated with the user device 112, such as it may indicate whether the vehicle has been tampered or is being stolen, as will be described in detail further below. Such a system may be applied and utilized with a car, a van, a truck (whether a four-wheel, 6-wheel, 18-wheel, and the like), a bike, a motorcycle, or any other type of vehicle. It is appreciated that although a single user device 112 is shown in FIG. 1, the system 100 may comprise a plurality of user devices associated with respective plurality of users and in communication with respective theft detection devices, and details explained with reference to the user device 112 and the theft detection device 102, are applicable for a plurality of user devices and plurality of theft detection devices as well.

The theft detection device 102 may be in communication with the processor 104 and/or the memory 106, or in some embodiments, the theft detection device 102 may be in communication with the processing unit 150. The processor 104 is configured to execute instructions stored in the memory 106. For instance, the processor 104 coordinates with the memory 106 to execute instructions to perform or control performance of methods described herein.

In some embodiments, the processor 104 or its functionality may be implemented via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

The memory 106 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, or the like. The machine readable storage medium may be encoded with executable instructions. In some embodiments, the memory 106 may comprise a cloud-based storage.

In some embodiments, the memory 106 may store various data such as threshold values with respect to different sensors, which may be generated in relation to methods and systems described herein. In some embodiments, all such data may be stored outside of the theft detection device 102, for example, all such data may be stored in the memory 106 being a cloud storage that may be accessible to the processor 104.

The processor 104, in turn, may include a central processing unit (CPU), a graphics processing unit (GPU), a microcontroller, a microprocessor, a processing core, a field-programmable gate array (FPGA), or similar device capable of executing instructions. In some embodiments, processor 104 may comprise a cloud based or virtualized processing module or functionality. For example, processors may execute the instructions stored in memory to perform or control performance of methods, including method 200, and the other methods for detection and prevention of vehicle theft disclosed herein.

The theft detection device 102 comprises a plurality of sensors 108a-108c. In one embodiment, the plurality of sensors 108a-108c may be a part of the theft detection device 102 and positioned together within the vehicle. In other embodiments, the plurality of sensors 108a-108c may be placed at various locations in the vehicle. In this embodiment, the plurality of sensors 108a-108c may each communicate with the processing unit 150 and/or the user device 112 via the communication network 120 as explained above. In some embodiments, the theft detection device 102 may comprise a power source 114 (e.g., a battery) allowing the theft detection device 102 to operate independently, such as, independently of any power dependency from the vehicle where the theft detection device 102 is positioned. In some embodiments, the theft detection device 102 may be a hardware component comprising the power source 114 positioned within the vehicle at one location and the sensors 108a-108c may be positioned at different locations within the vehicle. The sensors 108a-108c may be in connection with the hardware component using wired or wireless means. In some embodiments, the theft detection device 102 may be positioned and secured within the vehicle via fastening means, such as, adhesive strips, hooks, and loops.

The plurality of sensors 108a-108c may comprise different types of sensors. For example, the plurality of sensors may comprise Sensor A 108a, Sensor B 108b, Sensor C 108c and the like. In some embodiments, the sensors 108a-108c may be battery-operated and rely on the power source 114 for operation. In some embodiments, each of the sensors 108a-108c may be in communication with the processing unit 150 and/or the user device 112 via the communication network 120, such as, via RF, WIFI, or Bluetooth. In an embodiment, Sensor A may be a motion sensor like a Passive Infrared (PIR) sensor. In an embodiment, a plurality of such motion sensors may be mounted on or inside a vehicle to detect the movement around the vehicle. For example, if a thief approaches near the vehicle or is inside the vehicle, the motion sensor may be configured to detect the presence of the thief in the field of detection of the motion sensor. Likewise, such a plurality of sensors may indicate when a person (driver or passenger) enters the subject vehicle at any time, thereby providing the impetus for notifying the app device of such an occurrence and allowing the device (app) user the ability to provide an indication of the acceptance (authorization) of the person or persons that have entered the vehicle at that time. The lack of acceptance within the device (app) may trigger a further communication request from the app system to the user (driver/passenger) such that a lack of response may itself trigger an alert to the local authorities. Such is discussed in greater detail below. In other embodiments, Sensor A may be a microwave motion sensor, or a hybrid motion sensor that incorporates both the PIR sensor as well as the microwave motion sensor and transmit the data to the processor 104.

In an embodiment, Sensor B 108b may be an audio-activated sensor. In an embodiment, a plurality of such audio-activated sensors may be mounted inside or outside the surface of the vehicle to record audio data such as noise of breaking glass. When a thief breaks into the vehicle by destroying the windshield or the window glass, a sound of breaking of glass is produced. This sound may be detected by the audio-activated sensor. In an embodiment, the audio-activated sensor is an analog microphone that is configured to detect the sound of a window glass breaking and transmit the data to the processor 104. The audio-activated sensor may detect frequency of noise signals ranging from 3 kHz to 6 kHz. The microphone may convert the sound signal into analog or digital signal. The audio-activated sensor may also comprise a comparator, such as LM393 comparator and an in-built potentiometer for sensitivity adjustment. Therefore, a user may calibrate the audio-activated sensor as per their needs.

In an embodiment, Sensor C 108c may comprise one or more vibration sensors. The one or more vibration sensors may be mounted inside or outside the surface of the vehicle to record vibrations occurring in the vehicle while a thief attempts to steal the vehicle. In cases when a thief tries to tamper with the vehicle, the vibration sensor may be configured to detect the vibrations in the vehicle and transmit the data to the processor 104. The vibration sensor may be any one of displacement sensor, velocity sensor, accelerometer, and the like.

The theft detection device 102 may optionally comprise a positioning system 110 to track the position of the vehicle at a particular instance. In one embodiment, the positioning system 110 may be a global positioning (GPS) system. In one embodiment, the positioning system may be configured to transmit live coordinates of the vehicle to the processor 104 after regular intervals. In another embodiment, the positioning system 110 may be configured to transmit live coordinates of the vehicle when queried by the processor, such as, upon receiving a query by a user via the user device 112. As described above, the positioning system 110 may communicate with the processor 104 and the memory 106 using the communication network 120. In some embodiments, the positioning system 110 may be configured to track a distance between the vehicle where the sensors 108a-108c are located and the user device 112. Upon determining that the distance exceeds a predetermined distance, such as 100 feet, the positioning system 110 may notify the processor 104 which may cause activation of the sensors 108a-108c. In some embodiments, the positioning system 110 may be implemented as a component of the theft detection device 102.

The theft detection device 102 may optionally include a database comprising information regarding the vehicle and the threshold levels of each sensor. The information may be pre-stored in the database. The database may be stored in the memory 106. In some embodiments, such information is dynamically updated in the database. Other information related to the vehicle may comprise physical characteristics of the vehicle, details of the owner, contact number of the owners etc. In another embodiment, the database may be external to the theft detection device 102, however, in communication therewith.

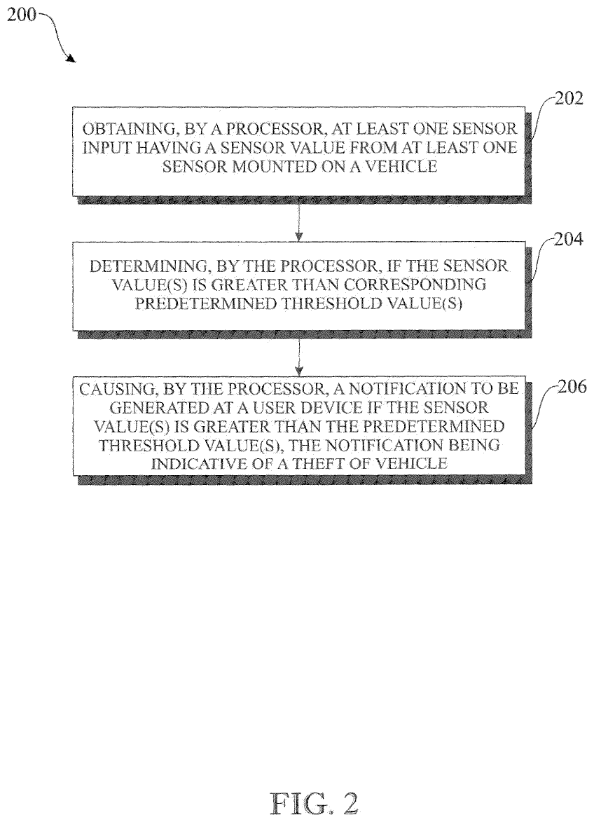

Reference is now made to FIG. 2 which illustrates a flowchart of an example method 200 for vehicle theft detection and prevention. The method 200 may be performed under control of the processing unit 150 in coordination with the theft detection device 102 and the user device 112.

In block 202, the processor 104 may obtain at least one sensor input from at least one sensor of the plurality of sensors 108a-108c. The sensor input may comprise a sensor value that is indicative of a reading or measurement of the corresponding sensor providing the sensor input. The sensor value may be a proximity value received from Sensor A 108a, the proximity value being indicative of measurements from the sensor A 108a regarding presence of any person who is within or near the vehicle where the sensor A 108a is positioned. The sensor value may be an audio value received from Sensor B 108b, the audio value being indicative of measurements from the sensor B 108b regarding any audio or noise generated within or near the vehicle where the sensor B 108b is positioned. The sensor value may be a vibratory value received from Sensor C 108c, the vibratory value being indicative of measurements from the sensor C 108c regarding any vibrations within or near the vehicle where the sensor C 108c is positioned. Alternatively, the sensor value may comprise the sensor values obtained from any two of the plurality of sensors 108a-108c. Alternatively, the sensor value may comprise the sensor values obtained from all the sensors 108a-108c.

In an embodiment, prior to block 202, the Sensor A 108a may be configured to remain active at all instances when the vehicle is in parked state, while Sensor B 108b and Sensor C 108c may be in sleep mode. The Sensor A 108a may be configured to send sensor inputs comprising the proximity values at a regular interval to the processor 104. The processor 104 may be configured to determine whether the proximity value is less than a predetermined threshold. In case, the proximity value is less than a predetermined threshold, the processor 104 may transmit signals to activate Sensor B 108b and Sensor C 108c from sleep mode. Thereafter, the Sensor B 108b and Sensor C 108c may transmit their corresponding sensor inputs with corresponding sensor values to the processor 104.

At block 204, the processor 104 may compare the sensor values received in the sensor inputs from at least one of the plurality of sensors 108a-108c with corresponding predetermined threshold values stored in the memory 106 or the database. For example, in the scenario where the sensor value received is a proximity value, the processor 104 is configured to compare the received proximity value with a predetermined threshold of proximity value. The processor 104 is configured to determine if the received proximity value exceeds the predetermined threshold of proximity value. In an example, the sensor A 108a may measure a proximity value that is greater than the predetermined threshold when a person (such as a thief) is within a particular distance from the vehicle and the sensor A 108a may measure a proximity value that is less than the predetermined threshold when a person (such as a thief) is away from the vehicle by a particular distance. In addition, or alternatively, in the scenario where the sensor value received is an audio value, the processor 104 is configured to compare the received audio value with a predetermined threshold of audio value. The processor 104 is configured to determine if the received audio value exceeds the predetermined threshold of audio value. In an example, the sensor B 108b may measure an audio value that is greater than the predetermined threshold when a person (such as a thief) has entered the vehicle, such as by breaking a window or forcefully opening a door, causing noise that is measured by the sensor B 108b. Similarly, the sensor B 108b may measure an audio value that is less than the predetermined threshold when no unexpected noise is emitted within or near the vehicle. In addition, or alternatively, in the scenario where the senor value received is a vibratory value, the processor 104 is configured to compare the vibratory value with a predetermined threshold of vibratory value and determine whether the received vibratory value exceeds the predetermined threshold of vibratory value. In an example, the sensor C 108c may measure a vibratory value that is greater than the predetermined threshold when a person (such as a thief) has entered the vehicle causing excess vibrations within the vehicle that are measured by the sensor C 108c.

It is to be appreciated that the sensor values may be negative numbers or positive numbers. Further, the sensor values may be integers or decimal values. In some embodiments, the sensor values within the sensor inputs may be stored in the memory 106, for instance as a list or table. In some embodiments, the predetermined thresholds for the respective sensor values may be stored in the memory 106 and may be accessed by the processor 104 for comparison.

At block 206, if it is determined that the sensor values within the sensor inputs exceeds the corresponding predetermined threshold value, the processor 104 may be configured to cause a notification to be generated at the user device 112. The generated notification may indicate that the vehicle is being tampered or has been stolen. Optionally, the processor 104 may query the live coordinates of the vehicle from the positioning system 110. The generated notification may additionally include the live coordinates of the vehicle.

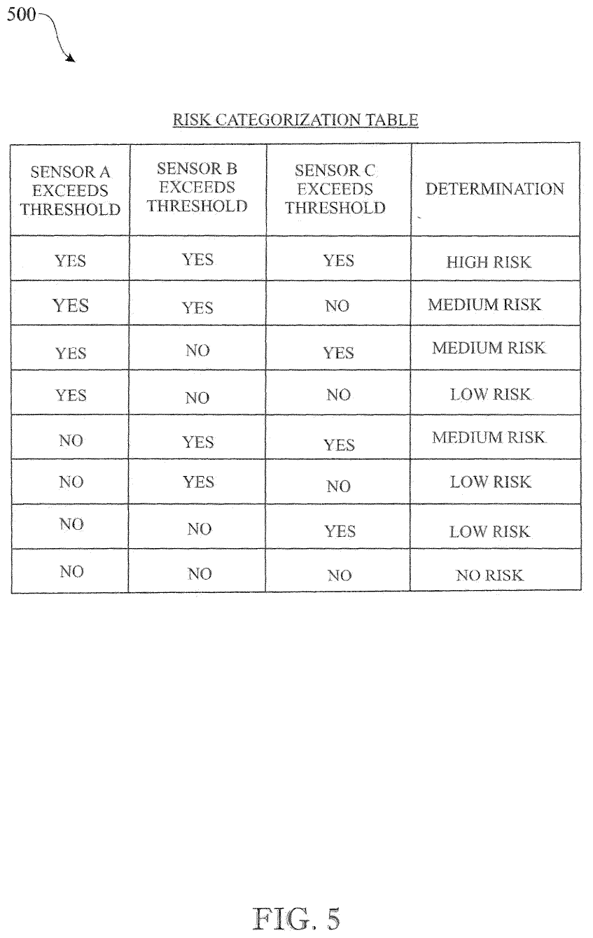

In an embodiment, where the processor 104 receives sensor values from more than one of the plurality sensors 108a-108c, the processor 104 may utilize a risk categorization rule to categorize the scenario as high risk, medium risk, low risk, or no risk. An example of one such risk categorization table is shown in FIG. 5. The risk categorization table may be stored in the memory 106 or in the database. In an embodiment, the risk categorization table may be modified by an owner of the vehicle as per their own requirements using an application on the user device 112.

If the processor 104 determines that the scenario is a high risk or medium risk scenario, the processor 104 may cause generation of the notification indicating that the vehicle is tampered or stolen. If the processor 104 determines that the scenario is a low risk, the processor 104 may cause generation of the notification indicating that the vehicle is likely to be stolen. If the processor 104 determines that the scenario is a no risk, the processor 104 may not cause generation of any notification at the user device 112.

In some embodiments, if the processor 104 determines that the scenario is a high risk or medium risk scenario, the processor 104 may cause generation of notification to a plurality of devices like a user device 112 associated with the owner of the vehicle and one or more user devices 112, which may be associated with the public safety officials.

The generated notification may be displayed to a user associated with the user device 112 via a text message, an email, a notification on an application installed on the user device 112, and the like.

In an embodiment, if it is determined that multiple vehicles of the same locality are stolen at the same time, the system 100 automatically transmits the notification to a user device associated with the relevant authorities such as a police officer.

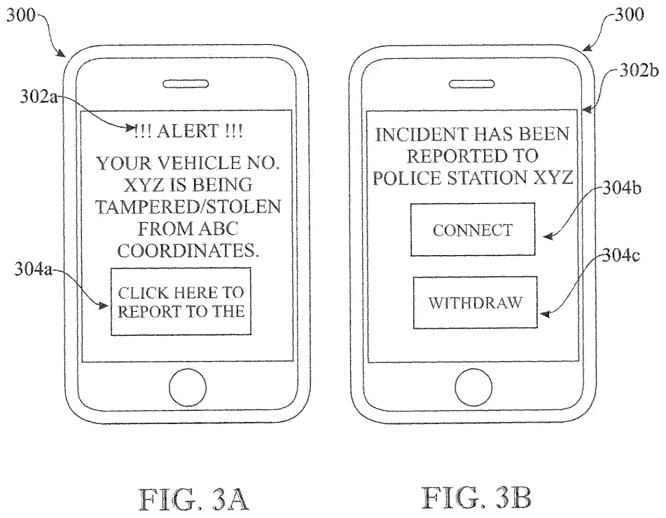

FIGS. 3A and 3B shows a screen capture of an example user interface of an application associated with a user device 300. The user device 300 may be similar to the user device 112 described in FIG. 1. It is to be appreciated that although the user device 300 is illustrated in FIGS. 3A and 3B as a mobile phone, the user device 300 may be a desktop computer, laptop computer, portable or mobile device, cell phone, smartphone, tablet computer, wearable device, or the like.

FIG. 3A represents a notification received from the theft detection device 102 on a user interface 302a (e.g., a graphical user interface (GUI) on the user device 300. The notification indicates a high-risk scenario stating that the vehicle has been stolen. The notification also indicates the coordinates of the location from where the vehicle has been stolen. Alternatively, the notification may also indicate the live coordinates of the location of the vehicle. In addition, the notification may indicate the time when the vehicle was being stolen. The notification may also indicate the information of the vehicle, for example, model number,

The user interface 302a further comprises an actionable button 304a, which when activated by the user, enables the user to send the same notification to the nearest police authorities. Once a user activates the actionable button 304a, the user interface 302b pops up as shown in FIG. 3B.

The user interface 302b indicates to the user that the police authorities have been notified of the theft. In case, the user wants to further connect with the police authorities, the user may have to activate an actionable button 304b. Subsequently, a call would be placed from the user device to the appropriate authorities.

In case the user finds that the incident was not a theft, for example, a car accident which was accidently detected as a theft, or in case the user had activated the actionable button 304b accidentally, the user may activate an actionable button 304c to withdraw the notification sent to the police authorities.

It is to be appreciated that FIGS. 3A and 3B represent example user interfaces. Different user interfaces may be adopted on the user device 300.

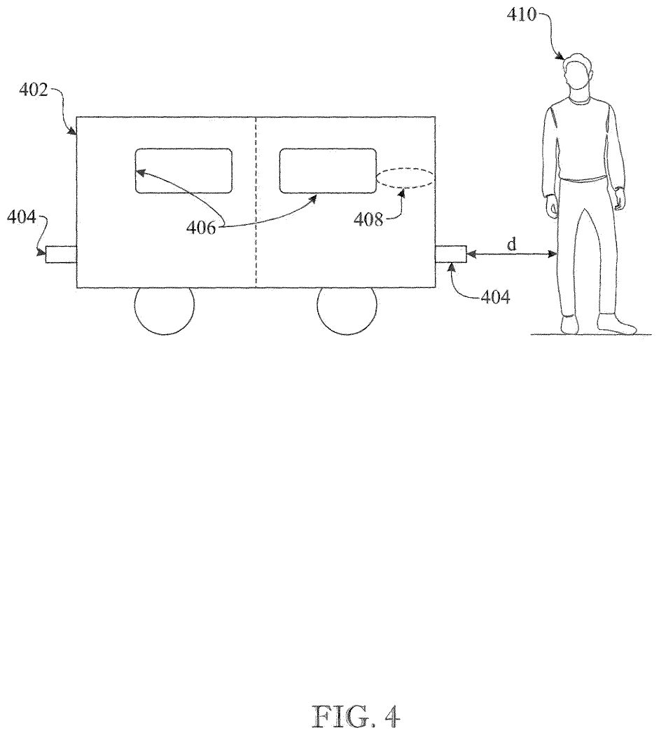

FIG. 4 shows an example representation of placement of plurality of sensors inside a vehicle 402. A plurality of proximity sensors 404 may be located on the outer surface of the vehicle. The plurality of proximity sensors 404 may correspond to Sensor A 108a described with respect to FIG. 1.

The plurality of proximity sensors 404 may be configured to detect movement or presence of an object or an animal near the vehicle 402. For example, as shown in FIG. 4, a person 410 is at distance d from the vehicle 402. The distance d may be a predetermined threshold of proximity value. If at any instance, the distance between the person 410 and the vehicle 402 is less than d, then at least one of the plurality of proximity sensors 404 may detect presence of the person 410.

A plurality of audio sensors 406 may be placed near the window, windshield, and the rear windshield of the vehicle 402 to capture the noise of glass when the glass breaks. The plurality of audio sensors 406 may correspond to Sensor B 108b described with respect to FIG. 1. The plurality of audio sensors 406 may be placed inside the vehicle 402 or on the outer surface of the vehicle 402.

A plurality of vibration sensors 408 may be placed at different locations in the vehicle 402. The plurality of vibration sensors may correspond to Sensor C 108c described with respect to FIG. 1. For example, the plurality of vibration sensors 408 may be placed near the steering wheel of the vehicle 402. Alternatively, the plurality of vibration sensors 408 may be placed near the brake or accelerator in the vehicle 402. In some embodiments, the plurality of vibration sensors 408 are inbuilt in the vehicle 402, for example, the accelerometer of the vehicle 402.

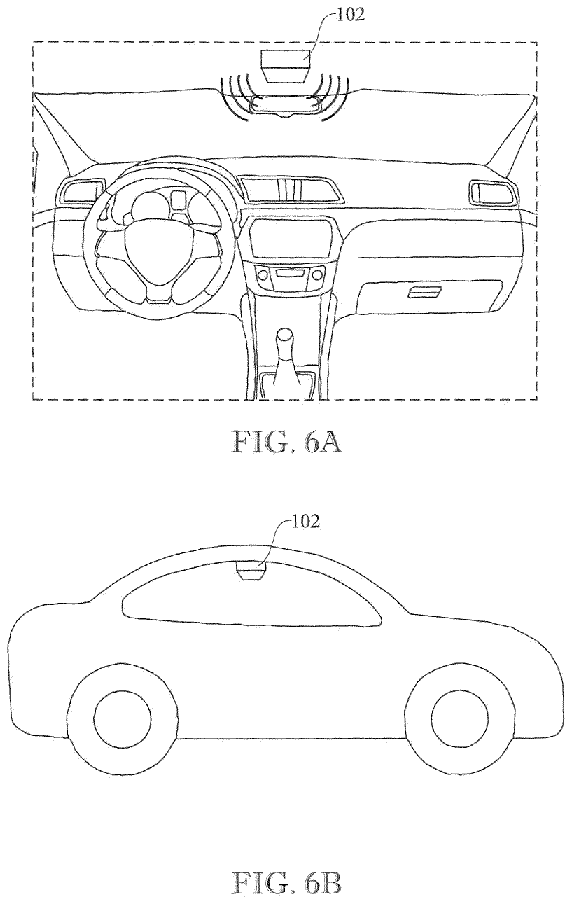

In some embodiments, the theft detection device 102 may be mounted inside the vehicle, for example, on a roof of the vehicle. FIGS. 6A and 6B show multiple views of the example vehicle with the theft detection device 102 mounted on the roof inside of the vehicle.

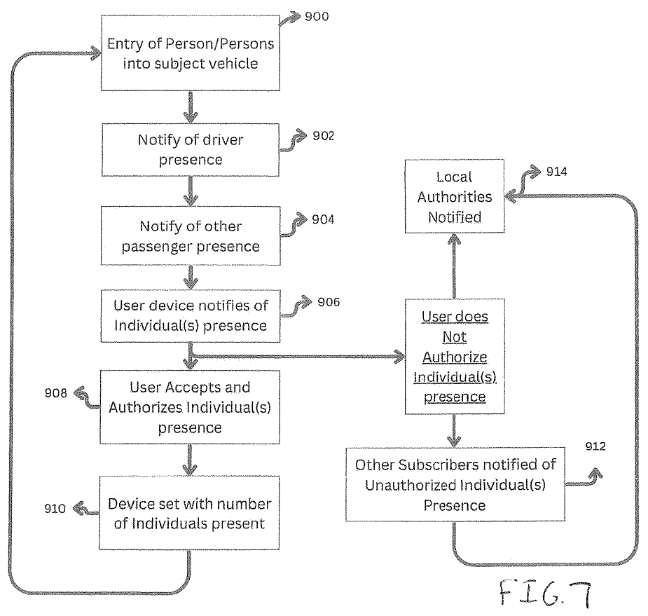

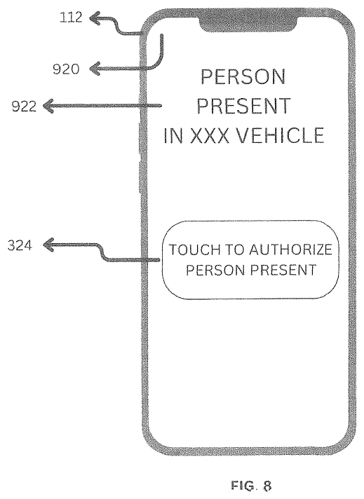

FIGS. 7 and 8 denote a flowchart in relation to a notification alternative provided by an embodiment of the system disclosed herein, as well as an app (device) communication platform associated therewith, respectively. As noted above, the versatility of the system device 102 coupled with the user device 112 permits a further capability of utilizing the motion sensor(s) (Sensor A 108a) to monitor when any person enters the subject vehicle. In this manner, it is possible, as delineated above, to couple such a motion sensor(s) 108a with the user device 112 as a way to first notify when a person/individual is present and/or at least enters the vehicle. The user device 112 may then indicate such an occurrence and provide a click button or other type of notation thereon (such as on a smartphone screen) to acknowledge such an occurrence and then denote whether such a person/individual is authorized as a driver/passenger therein. As alluded to above, this gives the ability to determine if an authorized person is present within the subject vehicle with the further capability of the user device 112 to potentially, at least, automatically inform the local authorities of the situation were the person present not authorized to be present. To that end, the system herein includes the system device 102 with at least the motion sensor 108a in place (and preferably a plurality thereof to provide more effective readings in terms of persons/individuals present within the subject vehicle as well as multiple components to keep hidden from view of any bad actors to prevent removal of all such sensors thereby upon entry within the vehicle). Upon entry into the subject vehicle 900, the motion sensor(s) 108a indicate the presence of a person 902 as well as the presence of any others 904. At such time, the user device 112 is then notified of such person entry 902, 904 and indicates as much on the user device 112, providing such notification to the user 906 and then generating a response button that indicates if the user authorizes each person present to be allowed within the subject vehicle 908. If the user hits ALLOW (or something akin to such a notation) 910, then all progresses ahead with the driver/passenger(s) in the subject vehicle without incident. If the user does not hit ALLOW, after 30 seconds (or any other time frame, as little as 10 seconds up to 1 minute, as examples), then the user device 112 (and the app thereof) automatically sends a notification to all other subscribers to the user device app 912 that an anomaly has occurred, as well as alerts the local authorities 914 that a theft or break-in has taken place in relation to the subject vehicle. As noted above, such an alert may include any related information to the subject vehicle including, without limitation, make, model, color, year of manufacture, license plate number, VIN, and/or owner name. A viable alternative benefit of this system is that upon the acceptance of the driver/passenger(s) 910, the system is set in place, thus allowing for the ability to notify if any other persons enters the subject vehicle thereafter the acceptance of driver/passenger(s) has occurred. In this manner, any further entry by another person within the subject vehicle, such as during a carjacking or like event, and the motion sensor(s) 108a may then send another notification to the user device 112 of the entry of a person within the subject vehicle. In such an instance, the lack of acceptance (failure to hit ALLOW or other type of button/icon on the device) will automatically notify the other subscribers as well as the local authorities of such a situation. In the event the driver/passenger user device 112 is stolen itself during such a carjacking or like event, the system thus allows for automated notifications of such a theft. This early notification thus provides the potential for facilitating location of the stolen subject vehicle quickly. The pertinent screen 920 on the user device 112 shows the notification 922 and the acceptance/ALLOW button 924 for such a purpose.

Accordingly, the present disclosure provides devices, systems, and methods that detect and prevent vehicle theft or burglary. It is to be appreciated that the devices, systems, and methods described herein may also be implemented in other scenarios, for example, theft detection and prevention or vehicle tampering in a house, malls, schools, banks, warehouses, factories, parking lots, parking structures, construction sites etc. The solution proposed herein is very easy, reliable, and inexpensive to timely detect and prevent the vehicle theft or burglary. An owner of the vehicle needs to only place the theft detection device in the vehicle and install the application (app) on their user device that communicates with the theft detection device. Further, the owner may customize the thresholds, notification settings, alarm generation settings as per their preferences in the application. Furthermore, the theft detection device disclosed herein is easy to use and does not require professional installation. The owner may simply plug or mount the theft detection device inside the vehicle, which is then ready to use.

In some embodiments the method or methods described above may be executed or carried out by a computing system including a tangible computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that a certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalents.

What I claim is:

1. A method to detect and prevent vehicle theft or burglary, the method comprising:
receiving, by a processor, at least one sensor input having a sensor value from at least one sensor of a plurality of sensors mounted on or inside the vehicle;
determining, by the processor, whether the sensor value received from the at least one sensor is greater than a predetermined threshold value corresponding to the at least one sensor;
and in response to the determination that that the sensor value is greater than the predetermined threshold value, causing an alarm notification to be generated at a user device, the alarm notification being indicative of vehicle theft or burglary.

2. The method of claim 1 further including automatically notifying local authority in the event multiple users of the device within a predetermined range are triggered.

3. A method of claim 1 further including having access to alert local authorities from an app in response to attempted burglary, theft, or unauthorized tampering of a vehicle.
